(19) United States
(12) Patent Application Publication
(10) Pub. No.: US 2005/0265612 A1
(43) Pub. Date: Dec. 1, 2005

(54) 3D wavelet video coding and decoding method and corresponding device

(75) Inventors: Arnaud Bourge, Paris (FR); Eric Barrau, Puteaux (FR); Marion Benetiere, Rueil-Malmaison (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg 1 (NL)

(21) Appl. No.: 10/521,128

(22) PCT Filed: Jul. 11, 2003
(86) PCT No.: PCT/IB03/03159

§ 371 Date: Jan. 12, 2005

(30) Foreign Application Priority Data
Jul. 17, 2002 (EP) 02291803.1

(51) Int. Cl. G06K 9/36; G06K 9/46

(52) U.S. Cl. 382/237

(57) ABSTRACT

The invention relates to a three-dimensional (3D) video coding method applied to a bitstream corresponding to an original video sequence that has been divided into successive groups of frames (GOFs). This coding method, applies to each successive GOF first a spatio-temporal analysis step, itself comprising a motion estimation sub-step, a motion compensated temporal filtering sub-step and a spatial analysis sub-step, and then an encoding step, itself comprising an entropy coding sub-step, performed on the low and high frequency temporal subbands resulting from the spatio-temporal analysis step and on motion vectors obtained by means of said motion estimation step, and an arithmetic coding sub-step, applied to the coded sequence thus obtained. According to the invention, the frequency subbands available at the end of the analysis step are coded in an order that corresponds to a reconstruction of the couples of frames in their original order, the bits necessary to decode the first couple being at the beginning or the coded bitstream, followed by the extra bits necessary to decode the second couple, and so on, up to the last couple.

### FIELD OF THE INVENTION

The present invention generally relates to the field of video compression and decompression and, more particularly, to a video coding method for the compression of a bitstream corresponding to an original video sequence that has been divided into successive groups of frames (GOFs) the size of which is N=2ⁿ with n=1, or 2, or 3, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
   a motion estimation sub-step;
   based on said motion estimation, a motion compensated temporal filtering sub-step, performed on each of the 2ⁿ⁻¹ couples of frames of the current GOF;
   a spatial analysis sub-step, performed on the subbands resulting from said temporal filtering sub-step;
b) an encoding step, said step itself comprising:
   an entropy coding sub-step, performed on said low and high frequency temporal subbands resulting from the spatio-temporal analysis step and on motion vectors obtained by means of said motion estimation step;
   an arithmetic coding sub-step, applied to the coded sequence thus obtained and delivering an embedded coded bitstream.

The invention also relates to a corresponding coding device, to a transmittable video signal generated by means of such a coding method, to a method for decoding said signal, and to a decoding device for carrying out said decoding method.

### BACKGROUND OF THE INVENTION

From MPEG-1 to H.264, standard video compression schemes were based on so-called hybrid solutions (an hybrid video encoder uses a predictive scheme where each frame of the input video sequence is temporally predicted from a given reference frame, and the prediction error thus obtained by difference between said frame and its prediction is spatially transformed, for instance by means of a bi-dimensional DCT transform, in order to get advantage of spatial redundancies). A different approach, later proposed, consists in processing a group of frames (GOF) as a three-dimensional (3D, or 2D+t) structure and spatio-temporally filtering it in order to compact the energy in the low frequencies (as described for instance in “Three-dimensional subband coding of video”, C. I. Podilchuk and al., IEEE Transactions on Image Processing, vol. 4, no. 2, February 1995, pp. 125-139). Moreover, the introduction of a motion compensation step in such a 3D subband decomposition scheme allows to improve the overall coding efficiency and leads to a spatio-temporal multiresolution (hierarchical) representation of the video signal thanks to a subband tree, as depicted in FIG. 1.

The 3D wavelet decomposition with motion compensation, illustrated in said FIG. 1, is similarly applied to successive groups of frames (GOFs). Each GOF of the input video, including in the illustrated case eight frames F1 to F8, is first motion-compensated (MC), in order to process sequences with large motion, and then temporally filtered (TF) using Haar wavelets (the dotted arrows correspond to a high-pass temporal filtering, while the other ones correspond to a low-pass temporal filtering). Three successive stages of decomposition are shown (L and H=first stage; LL and LH=second stage; LLL and LLH=third stage). The high frequency subbands of each temporal level (H, LH and LLH in the above example) and the low frequency subband(s) of the deepest one (LLL) are spatially analyzed through a wavelet filter. An entropy encoder then allows to encode the wavelet coefficients resulting from the spatio-temporal decomposition (for example, by means of an extension of the 2D-SPIHT, originally proposed by A. Said and W. A. Pearlman in “A new, fast, and efficient image codec based on set partitioning in hierarchical trees”, IEEE Transactions on Circuits and Systems for Video Technology, vol. 6, no. 3, June 1996, pp. 243-250, to the present 3D wavelet decomposition, in order to efficiently encode the final coefficient bitplanes with respect to the spatio-temporal decomposition structure).

However, all the 3D subband solutions suffer from the following drawback: since an entire GOF is processed at once, all the pictures in the current GOF have to be stored before being spatio-temporally analyzed and encoded. The problem is the same at the decoder side, where all the frames of a given GOF are decoded together. A solution to said problem is described in a european patent application filed by the applicant on Jun. 28, 2002, with the registration number 02291621.7 (PHFR020065). In said document, the proposed low-memory solution, in which a progressive branch-by branch reconstruction of the frames of a GOF of the sequence is performed instead of a reconstruction of the whole GOF at once, is based on the following remarks. As illustrated in FIG. 2 (in the case of a GOF of eight frames for the sake of simplicity of the figure), said frames F1 to F8 are grouped into four couples of frames C0 to C3. At the end of the first step of the temporal decomposition of the original sequence, low frequency temporal subbands L0, L1, L2, L3 and high frequency temporal subbands H0, H1, H2, H3 are available. While the subbands H0 to H3 are coded and transmitted, the subbands L0 to L3 are further decomposed: at the end of this second step of the decomposition, low frequency temporal subbands LL0, LL1 and high frequency temporal subbands LH0, LH1 are available. Similarly, while the subbands LH0, LH1 are coded and transmitted, the subbands LL0, LL1 are further decomposed and, at the end of the third step of decomposition (the last one in the illustrated case), a low frequency temporal subband LLL0 and a high frequency temporal subband LLH0 are available and will be coded and transmitted. The whole set of transmitted subbands is surrounded by a black line in FIG. 2.

It appears that only the subbands H0, LH0, LLH0 and LLL0 are needed to decode the first two frames F1, F2 (i.e. the couple C0) of the GOF. Furthermore, the first subband H0 contains some information only on these two first frames F1,F2. So, once these frames F1, F2 are decoded, the first subband H0 becomes useless and can be deleted and replaced: the next subband H1 is now loaded in order to decode the next couple C1 including the two frames F3, F4. Only the subbands H1, LH0, LLL0 and LLH0 are now needed to decode these frames F3, F4 and, as previously for H0, the subband H1 contains some information only on these two frames F3, F4. So, once these two frames F3, F4 are decoded, the second subband H1 can be deleted, and replaced by H2. And so on: these operations are repeated for F5,F6 and F7,F8 (in the general case, for all the successive couples of frames of the GOF). The bitstream (the illustrated organization of which is only an example that does not limit the scope of the invention at the decoding side) thus formed for each successive GOF may be encoded by means of an entropy coder followed by an arithmetic coder (for instance, referenced 21 and 22 respectively). In the illustrated specific example, the coded bitstream finally available (and transmitted or stored) successively comprises, for the current GOF, a header and the coding bits corresponding to the subbands LLL0, LLH0, LH0, LH1, H0, H1, H2 and H3.

The practical operations performed according to the low-memory solution proposed in the cited european patent application were then the following. The part of the coded bitstream corresponding to the current GOF is decoded a first time, but only the coded part that, in said bitstream, corresponds to the first couple of frames C0 (the two first frames F1 and F2)—i.e. the subbands H0, LH0, LLL0, LLH0—is, in fact, stored and decoded. When the first two frames F1, F2 have been decoded, the first H subband, referenced H0, becomes useless and its memory space can be used for the next subband to be decoded. The coded bitstream is therefore read a second time, in order to decode the second H subband, referenced H1, and the next couple of frames C1 (F3, F4). When this second decoding step has been performed, said subband H1 becomes useless and the first LH subband too (referenced LH0). They are consequently deleted and replaced by the next H and LH subbands (respectively referenced H2 and LH1), that will be obtained thanks to a third decoding of the same input coded bitstream, and so on for each couple of frames of the current GOF.

This multipass decoding solution, comprising an iteration per couple of frames in a GOF, is detailed with reference to FIGS. 3 to 6. During the first iteration, the coded bitstream CODB received at the decoding side is decoded by an arithmetic decoder 31, but only the decoded parts corresponding to the first couple of frames C0 are stored, i.e. the subbands LLL0, LLH0, LH0 and H0 (see FIG. 3). With said subbands, the inverse operations (with respect to those illustrated in FIG. 1) are then performed:
the decoded subbands LLL0 and LLH0 are used to synthesize the subband LL0;
said synthesized subband LL0 and the decoded subband LH0 are used to synthesize the subband L0;
said synthesized subband L0 and the decoded subband H0 are used to reconstruct the two frames F1, F2 of the couple of frames C0.

When this first decoding step is achieved, a second one can begin. The coded bitstream is read a second time, and only the decoded parts corresponding to the second couple of frames C1 are now stored: the subbands LLL0, LLH0, LH0 and H1 (see FIG. 4). In fact, the dotted information of FIG. 4 (LLL0, LLH0, LL0, LH0) can be reused from the first decoding step (this is especially true for the bitstream information after the arithmetic decoding, because buffering this compressed information is not really memory consuming). With these subbands, the following inverse operations are now performed:
the decoded subband LLL0 and LLH0 are used to synthesize the subband LL0;
said synthesized subband LL0 and the decoded subband LH0 are used to synthesize the subband L1;
said synthesized subband L1 and the decoded subband H1 are used to reconstruct the two frames F3, F4 of the couple of frames C1.

When this second decoding step is achieved, a third one can begin similarly. The coded bitstream is read a third time, and only the decoded parts corresponding to the third couple of frames C2 are now stored: the subbands LLL0, LLH0, LH1 and H2 (see FIG. 5). As previously, the dotted information of FIG. 5 (LLL0, LLH0) can be reused from the first (or second) decoding step. The following inverse operations are performed:
the decoded subbands LLL0 and LLH0 are used to synthesize the subband LL1;
said synthesized subband LL1 and the decoded subband LH1 are used to synthesize the subband L2;
said synthesized subband L2 and the decoded subband H2 are used to reconstruct the two frames F5, F6 of the couple of frames C2.

When this third decoding step is achieved, a fourth one can begin similarly. The coded bitstream is read a fourth time (the last one for a GOF of four couples of frames), only the decoded parts corresponding to the fourth couple of frames C3 being stored: the subbands LLL0, LLH0, LH1 and H3 (see FIG. 6). Similarly, the dotted information of FIG. 6 (LLL0, LLH0, LL1, LH1) can be reused from the third decoding step. The following inverse operations are performed:
the decoded subbands LLL0 and LLH0 are used to synthesize the subband LL1;
said synthesized subband LL1 and the decoded subband LH1 are used to synthesize the subband L3;
said synthesized subband L3 and the decoded subband H3 are used to reconstruct the two frames F7, F8 of the couple of frames C3.

This procedure is repeated for all the successive GOFs of the video sequence. When decoding the coded bitstream according to this procedure, at most two frames (for example: F1, F2) and four subbands (with the same example: H0, LH0, LLH0, LLL0) have to be stored at the same time, instead of a whole GOF. A drawback of that low-memory solution is however its complexity. The same input bitstream has to be decoded several times (as many times as the number of couples of frames in a GOF) in order to decode the whole GOF.

### SUMMARY OF THE INVENTION

It is therefore a first object of the invention to propose a coding method allowing to significantly reduce at the decoding side the memory space needed to decode the 3D subband encoded bitstream while avoiding the previous iterative solution.

To this end, the invention relates to a video coding method such as defined in the introductory part of the description and which is further characterized in that, in the encoding step, the 2ⁿ frequency subbands available at the end of the analysis step for each GOF are coded in an order that corresponds to a progressive reconstruction of the couples of frames of said GOF in their original order, the bits necessary to later decode the first couple of frames being at the beginning of the coded bitstream, followed by the extra bits necessary to decode the second couple of frames, and so on, up to the last couple of frames of the current GOF. The invention also relates to a corresponding coding device, allowing to carry out said coding method.

It is also an object of the invention to propose a transmittable video signal consisting of a coded bitstream generated by such a coding method, a method for decoding said signal, using a reduced memory space with respect to the decoding method previously described, and a corresponding decoding device, allowing to carry out said decoding method.

### BRIEF DESCRIPTION OF DRAWINGS

The present invention will now be described, by way of example, with reference to the accompanying drawings in which:

FIG. 1 illustrates a 3D subband decomposition, performed in the present case on a group of eight frames;

FIG. 2 shows, among the subbands obtained by means of said decomposition, the subbands that are transmitted and the bitstream thus formed;

FIGS. 3 to 6 illustrate, in a decoding method already proposed by the applicant, the operations iteratively performed for decoding the input coded bitstream;

FIG. 7 illustrates the basic principle of a video coding method according to the invention;

FIGS. 8 to 10 show respectively the three successive parts of a flowchart that illustrates an implementation of the video coding method according to the invention;

FIG. 11 illustrates a decoding method according to the invention.

### DETAILED DESCRIPTION OF THE INVENTION

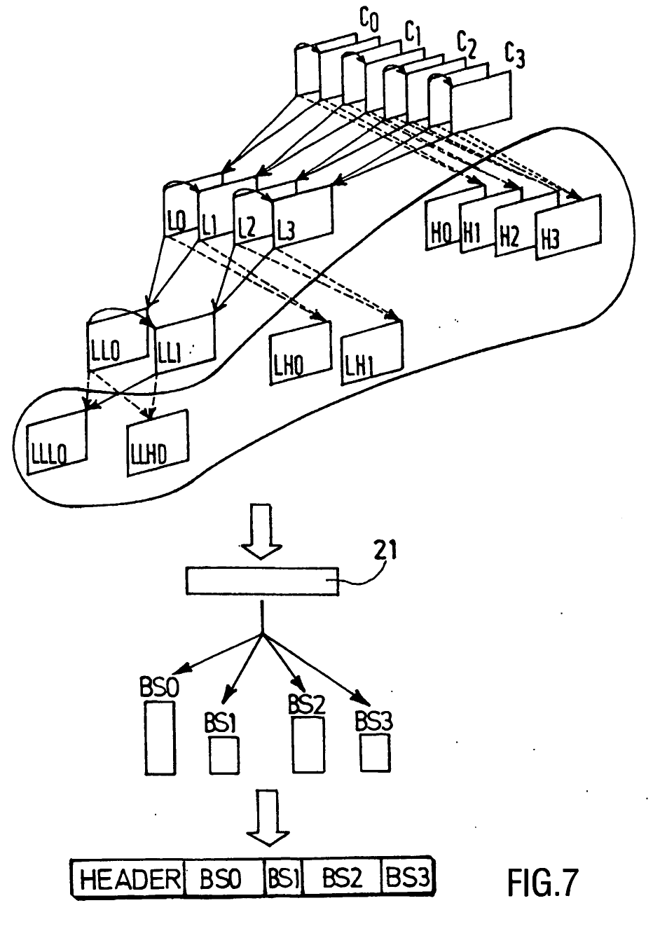

The principle of the invention is the following: the input bitstream is re-organized at the coding side in such a way that the bits necessary to decode the first two frames are at the beginning of the bitstream, followed by the extra bits necessary to decode the second couple of frames, followed by the extra bits necessary to decode the third couple of frames, etc. This solution according to the invention is illustrated in FIG. 7, in the case of n=3 decomposition levels, but said solution is obviously applicable whatever the number n of these levels. At the output of the entropy coder 21, the available bits b are now organized in bitstreams BS0, BS1, BS2, BS3 that respectively correspond to:
the subbands LLL0, LLH0, LH0, H0 useful to reconstruct at the decoding side the couple of frames C0;
the extra subband H1, useful (in association with the subbands LLL0, LLH0, LH0 already put in the bitstream) to reconstruct the couple of frames C1;
the extra subbands LH1, H2 useful (in association with the subbands LLL0, LLH0 already put in the bitstream) to reconstruct the couple of frames C2;
the extra subband H3, useful (in association with the subbands LLL0, LLH0, LH1 already put in the bitstream) to reconstruct the couple of frames C3.

As indicated, these elementary bitstreams BS0 to BS3 are then concatenated in order to constitute the global bitstream BS which will be transmitted. In said bitstream BS, it does not mean that the part BS1 (for example) is sufficient to reconstruct the frames F3, F4 or even to decode the associated subband H1. It only means that with the part BS0 of the bitstream, the minimum amount of information needed to decode the first two frames F1, F2 (couple C0) is available, then that with said part BS0 and the part BS1, the following couple of frames C1 can be decoded, then that with said parts BS0 and BS1 and the part BS2, the following couple of frames C2 can be decoded, and then that with said parts BS0, BS1, BS2 and the part BS3, the last couple of frames C3 can be decoded (and so on, in the general case of 2ⁿ couples of frames in a GOF).

With this re-organized bitstream, the multiple-pass decoding scheme as previously proposed is no longer necessary. The coded bitstream has been organized in such a way that, at the decoding side, every new decoded bit is relevant for the reconstruction of the current frames.

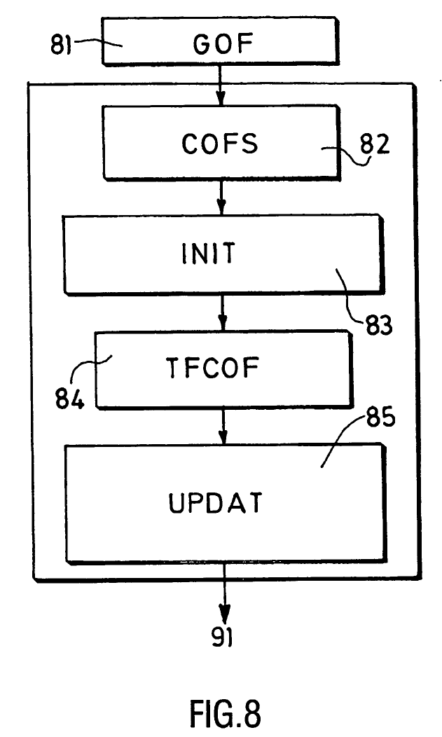

An implementation of the video coding method according to the invention is illustrated in the flowchart of FIGS. 8 to 10. As illustrated in FIG. 8 with the references 81 to 85, the current GOF (81) comprises N=2ⁿ frames A0, A1, A2, . . . , A(N−1) which are organized (step 82) in successive couples of frames (or COFs) C0=(A0, A1), C1=(A2, A3), . . . , C((N/2)−1)=(A(N−2), A(N−1)). At the first temporal level TL1, the temporal filtering step TF is first performed on each couple of frames (step TFCOF 84), which leads to outputs TF(C0)=(L[1,0], H[1,0]), TF(C1)=(L[1,1], H[1,1]), . . . , TT(C((N/2)−1))=(L[1,((N/2)−1)], H[1, ((N/2)−2)]), in which L[.] and H[.] designate the low frequency and high frequency temporal subbands thus obtained. An updating step 85 (UPDAT) then allows to store the logical indication of a connection between each couple of frames C0, C1, etc. . . . , and each subband that contains some information on the concerned couple of frames. These connections between a given couple of frames and a given subband is indicated by logical relations of the type:
L[1,0]_IsLinkedWith_C0=TRUE
H[1,0]_IsLinkedWith_C0=TRUE
L[1,1]_IsLinkedWith_C1=TRUE
H[1,1]_IsLinkedWith_C1=TRUE
etc. . . .
   (said logical relations have been previously initialized in the step INIT 83: “for all temporal subbands S, for all couples C, S_IsLinkedWith_C=FALSE”).

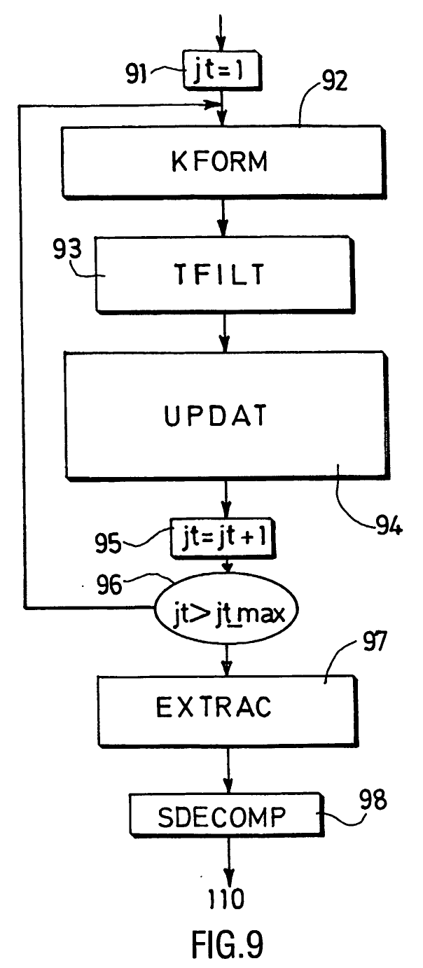

As illustrated in FIG. 9 with the references 91 to 98, the subband decomposition can then take place, between the operation 91 called jt=1 (=beginning of the first temporal decomposition level) and the operation 95 called jt=jt+1 (=control of the following temporal decomposition level, according to the feedback connection indicated in FIG. 9 and activated only if, after a test 96, jt is lower than a predetermined value jt_max correlated to the number of frames within each GOF). At each temporal decomposition level, new couples K are formed (step KFORM 92) with the L subbands, according to the relations:
K0=(L[jt, 0], L [jt, 1])
K1=(L[jt, 2], L [jt, 3])
. . .
   and a temporal filtering step TF is once more performed (step TFILT 93) on these new K couples:
TF(K0)=(L[jt+1, 0], H [jt+1, 0])
TF(K1)=(L[jt+1, 1], H [jt+1, 1])
. . .

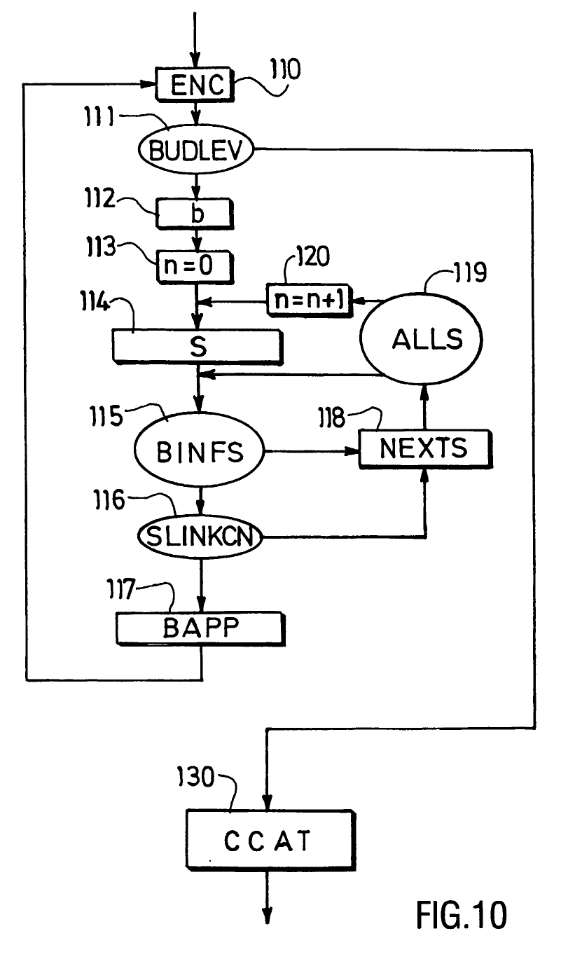

An updating step 94 (UPDAT) is then provided for establishing a connection between each of the subbands thus obtained and the original couples of frames, i.e. for determining if a given subband will be involved or not at the decoding side in the reconstruction of a given couple of frames of the current GOF. At the end of the temporal decomposition, the following subbands:
L(jt_max, n), for n=0 to N/2^{jt},
H(jt, n), for jt=1 to jt_max and n=0 to N/(2^{jt}),
   which correspond to the subbands to be transmitted, are extracted (step EXTRAC 97). This ensemble is called T in the following part of the description. A spatial decomposition of said subbands is then performed (step SDECOMP 98), and the resulting subbands are finally encoded according to the flowchart of FIG. 10, in such a way that the output coded bitstream BS (such as shown in FIG. 7) is finally obtained.

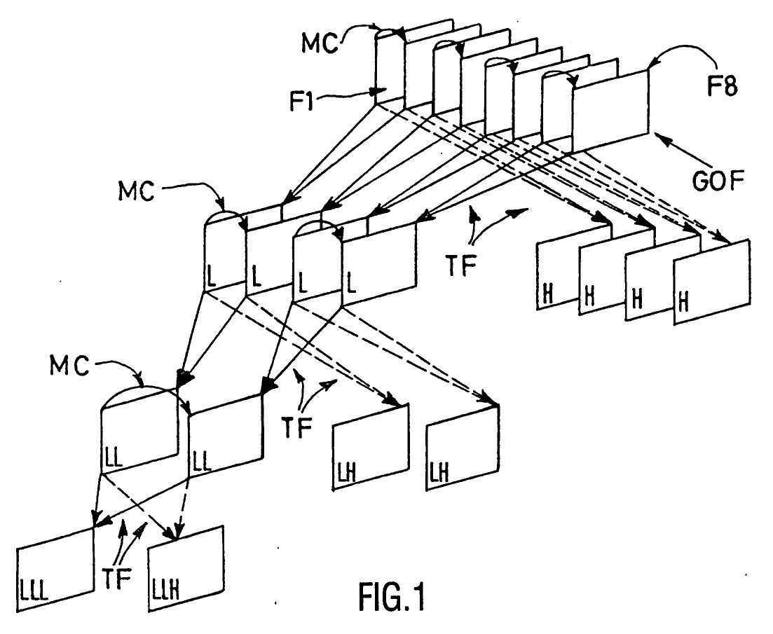

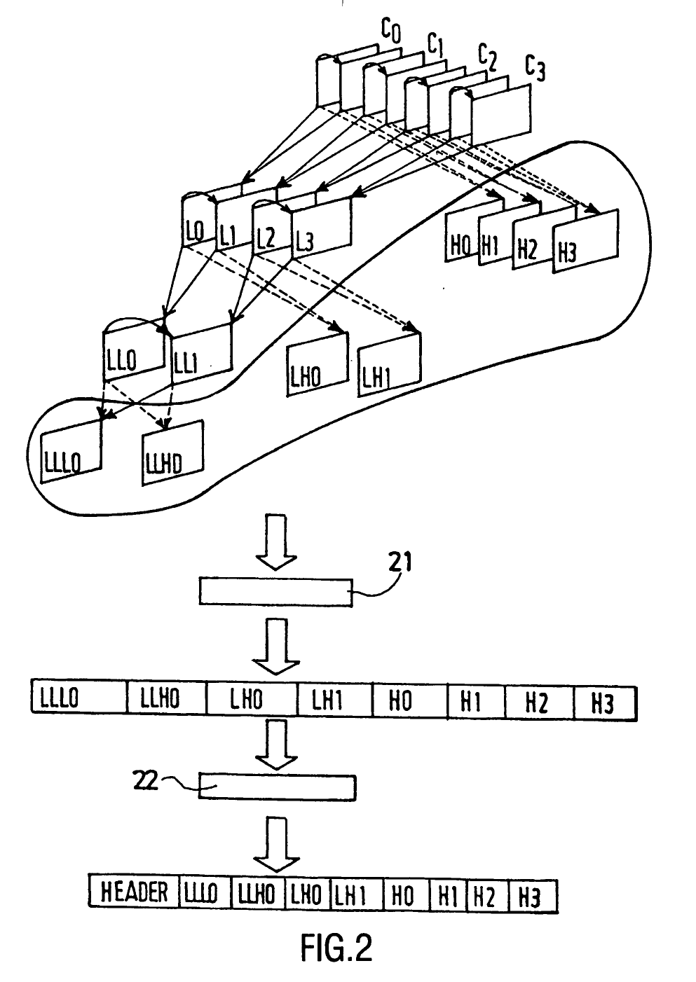

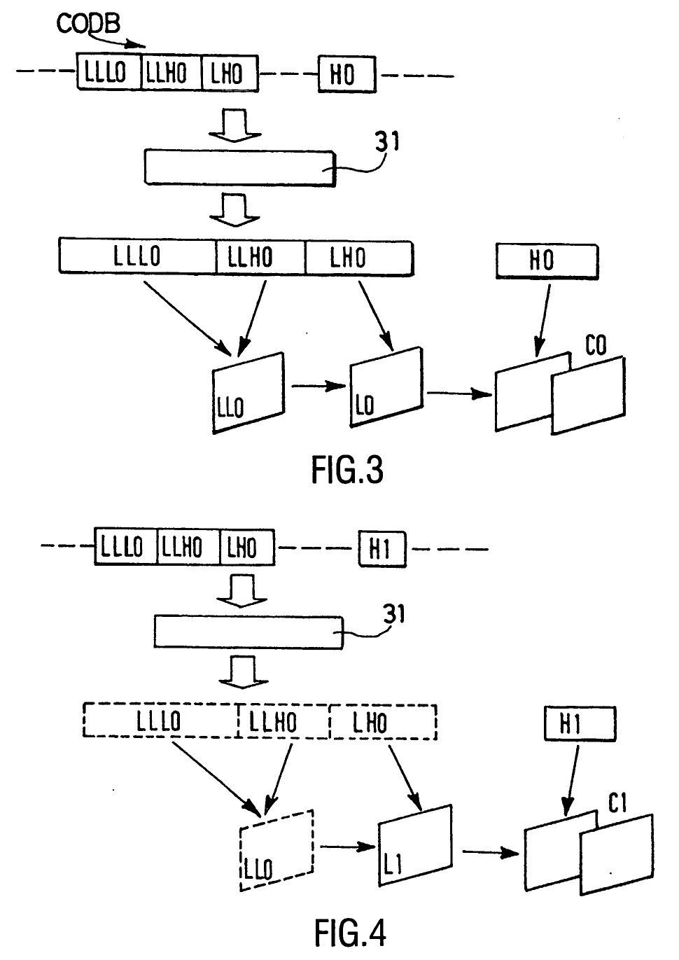

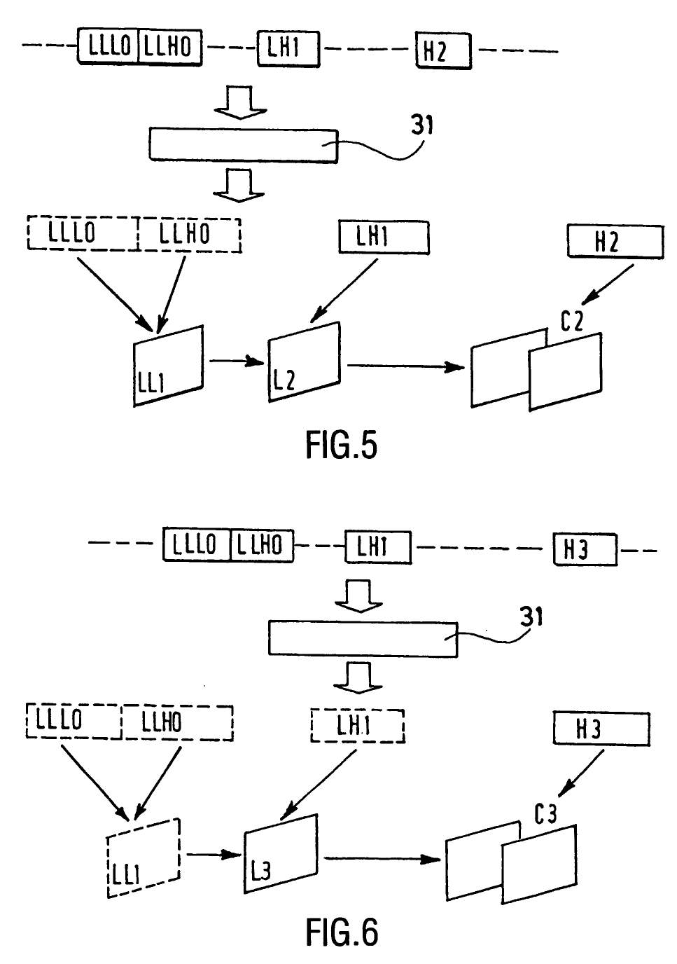

After an entropy coding step 110 (ENC), a control (step BUDLEV 111) of the bit budget level is performed at the output of the encoder. If the bit budget is not reached, the current output bit b is considered (step 112), n is initialized (step 113), and a test 115 is performed on a considered subband S (step 114) from the ensemble T. If b contains some information about S (step BINFS 115) and if S is linked with the couple Cn (step SLINKCN 116), the concerned bit b is appended (step BAPP 117) to the bitstream BSn (n=0, 1, 2, 3 in the example previously given with reference to FIGS. 1 to 7) and the following output bit b is considered (i.e. a repetition of the steps 111 to 117 is carried out). If b does not contain any information about S, or if S is not linked with the couple Cn, the next subband S is considered (step NEXTS 118). If all subbands in T have not been considered (step ALLS 119), the operations (steps 115 to 118) are further performed. If all said subbands have been parsed, the value of n is increased by one (step 120), and the operations (steps 114 to 120) are further performed for the next original couple of frames (and so on, up to the last value of n). At the output of the coding step 110, if the bit budget has been reached, no more output b is considered.

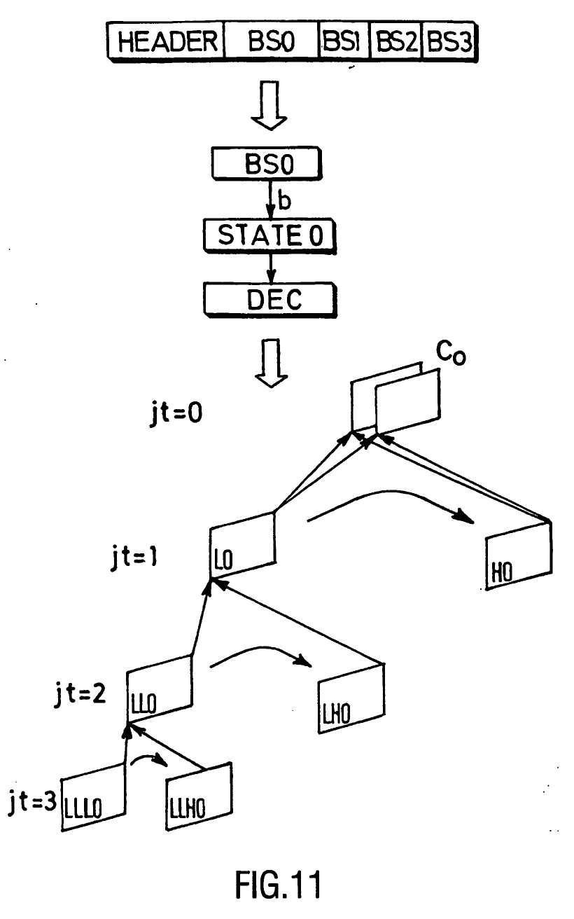

Finally, when all output bits have been considered or if the bit budget has been reached (step 111), the whole coding step is considered as achieved and the individual bitstream BSn obtained are concatenated (step CCAT 130) into the final bitstream BS (from n=0 to its maximum value). At the decoding side, the decoding step is performed as now explained with reference to FIG. 11, where “state 0” (1, 2, . . . , n) means that the functioning of the entropy encoder is constrained by the reconstruction of a unique couple, C0 in the present case (C0, C1, C2, . . . ,Cn in the general case) with n=0 to 3 in the illustrated example. In practice, when a bit b of the coded bitstream is received and decoded, it is interpreted as containing some pixel significance (or set significance) information related to a pixel in a given spatio-temporal subband (or to several pixels in a set of such subbands). If none of these subbands contributes to the reconstruction of the current couple of frames Cn (C0 in the illustrated example), the bit b has to be re-interpreted, the entropy decoder DEC jumping to its next state until b is interpreted as contributing to the reconstruction of Cn (C0 in the present case). And so on for the next bit, until the current sub-bitstream is completely decoded.

The described functioning of the decoding of the first couple C0 (state “0”) is therefore fairly straightforward with the above explanations, and FIG. 11 shows clearly the 3D subband spatio-temporal synthesis of the couple of frames C0: at the third decomposition level jt=3, the subbands LLL0 and LLH0 are combined (dotted arrows) with motion compensation, in order to synthesize the appropriate subband LL0 of the second decomposition level jt=2, said subband LL0 and the subband LH0 are in turn combined, with motion compensation, in order to synthesize the appropriate subband L0 of the first decomposition level jt=1, and said subband L0 and the subband H0 are in turn combined, with motion compensation, in order to synthesize the concerned couple of frames C0 (jt=0). More generally, if the size of the complete GOF is N=2′, (n+1) temporal subbands (one low frequency temporal subbands and n high frequency temporal subbands) have to be decoded and (n−1) low frequency temporal subbands have to be reconstructed, which corresponds to a noticeable reduction of memory space with respect to the case of the decoding and recontruction of the entire GOF at once. In the illustrated case, at each step, the reconstructed low frequency subband of the lower temporal level (e.g. LL0, at jt=2) is written over the previous one (e.g. LLL0, at jt=3), that gets lost. Thus there are never more than (n+1) temporal subbands stored in memory.

1. A video coding method for the compression of a bitstream corresponding to an original video sequence that has been divided into successive groups of frames (GOFs) the size of which is N=2ⁿ with n=1, or 2, or 3, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said temporal filtering sub-step;
b) an encoding step, said step itself comprising:
an entropy coding sub-step, performed on said low and high frequency temporal subbands resulting from the spatio-temporal analysis step and on motion vectors obtained by means of said motion estimation step;
an arithmetic coding sub-step, applied to the coded sequence thus obtained and delivering an embedded coded bitstream;
said coding method being further characterized in that, in the encoding step, the 2ⁿ frequency subbands available at the end of the analysis step for each GOF are coded in an order that corresponds to a progressive reconstruction of the couples of frames of said GOF in their original order, the bits necessary to later decode the first couple of frames being at the beginning of the coded bitstream, followed by the extra bits necessary to decode the second couple of frames, and so on, up to the last couple of frames of the current GOF.

2. A coding method according to claim 1, characterized in that, n being equal to 3, among the set of subbands available for the current GOF at the end of said analysis step and comprising the high frequency temporal subbands (H0, H1, H2, H3) of the first decomposition level, the high frequency temporal subbands (LH0, LH1) of the second decomposition level and the low and high frequency temporal subbands (LLL0, LLH0) of the third decomposition level, the subbands (LLL0, LLH0, LH0, H0) are first coded, then the subband H1, then the subbands (LH1, H2), and then the subband H3.

3. A video coding device for the compression of a bitstream corresponding to an original video sequence that has been divided into successive groups of frames (GOFs) the size of which is N=2ⁿ with n=1, or 2, or 3, . . . , said coding device comprising, for generating the coded bitstream:
motion estimation means, applied to the frames of each current GOF of the sequence;
motion compensated temporal filtering means, performed on each of the 2ⁿ⁻¹ couples of frames of the current GOF on the basis of motion vectors thus estimated;
spatial analysis means, performed on the subbands thus obtained;
encoding means, applied to the 2ⁿ low and high frequency temporal subbands of the spatio-temporal multiresolution decomposition of the current GOF obtained by means of the spatio-temporal analysis thus performed, said encoding means themselves comprising entropy coding means, applied to said low and high frequency temporal subbands and on said motion vectors, and arithmetic coding means, applied to the coded sequence thus obtained, said encoding means being moreover characterized in that they are applied to said 2ⁿ frequency subbands in an order that corresponds to a progressive reconstruction of the couples of frames of said GOF in their original order, the bits necessary to later decode the first couple of frames being at the beginning of the coded bitstream, followed by the extra bits necessary to decode the second couple of frames, and so on, up to the last couple of frames of the current GOF.

4. A transmittable video signal consisting of a coded bitstream generated by a video coding method for the compression of a bitstream corresponding to an original video sequence that has been divided into successive groups of frames (GOFs) the size of which is N=2ⁿ with n=1, or 2, or 3, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said temporal filtering sub-step;
b) an encoding step, said step itself comprising:
an entropy coding sub-step, performed on said low and high frequency temporal subbands resulting from the spatio-temporal analysis step and on motion vectors obtained by means of said motion estimation step;
an arithmetic coding sub-step, applied to the coded sequence thus obtained and delivering an embedded coded bitstream;
said encoding step being applied to the 2ⁿ frequency subbands available at the end of the analysis step for each GOF in an order that corresponds to a progressive reconstruction of the couples of frames of said GOF in their original order, the bits necessary to later decode the first couple of frames being at the beginning of said coded bitstream, followed by the extra bits necessary to decode the second couple of frames, and so on, up to the last couple of frames of the current GOF.

5. A video decoding method for the decompression of a coded bitstream corresponding to an original video sequence that has been divided into successive groups of frames (GOFs) the size of which is N=2ⁿ with n=1, or 2, or 3, . . . , and obtained by means of a coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said temporal filtering sub-step;
b) an encoding step, said step itself comprising:
an entropy coding sub-step, performed on said low and high frequency temporal subbands resulting from the spatio-temporal analysis step and on motion vectors obtained by means of said motion estimation step;
an arithmetic coding sub-step, applied to the coded sequence thus obtained and delivering an embedded coded bitstream;
said encoding step being applied to the 2ⁿ frequency subbands available at the end of the analysis step for each GOF in an order that corresponds to a progressive reconstruction of the couples of frames of said GOF in their original order, the bits necessary to later decode the first couple of frames being at the beginning of said coded bitstream, followed by the extra bits necessary to decode the second couple of frames, and so on, up to the last couple of frames of the current GOF.

6. A video decoding device for the decompression of coded bitstream corresponding to an original video sequence that has been divided into successive groups of frames (GOFs) the size of which is N=2ⁿ with n=1, or 2, or 3, . . . , and obtained by means of a coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said temporal filtering sub-step;
b) an encoding step, said step itself comprising:
an entropy coding sub-step, performed on said low and high frequency temporal subbands resulting from the spatio-temporal analysis step and on motion vectors obtained by means of said motion estimation step;
an arithmetic coding sub-step, applied to the coded sequence thus obtained and delivering an embedded coded bitstream;
said encoding step being applied to the 2ⁿ frequency subbands available at the end of the analysis step for each GOF in an order that corresponds to a progressive reconstruction of the couples of frames of said GOF in their original order, the bits necessary to later decode the first couple of frames being at the beginning of said coded bitstream, followed by the extra bits necessary to decode the second couple of frames, and so on, up to the last couple of frames of the current GOF, and said decoding device comprising means for decoding said 2ⁿ frequency subbands in said order, up to the reconstruction of all the couples of frames of said current GOF.
